(19) United States
(12) Patent Application Publication
(10) Pub. No.: US 2023/0304389 A1
(43) Pub. Date: Sep. 28, 2023

(54) Systems And Method For Creating A Predictive Model For Optimizing Drill Parameters

(71) Applicant: Chevron U.S.A. Inc., San Ramon, CA (US)

(72) Inventors: Matthew Scott Bolen, The Woodlands, TX (US); Devanand Ramchune, Humble, TX (US); Ryan Michael Weller, Houston, TX (US)

(21) Appl. No.: 17/656,185

(22) Filed: Mar. 23, 2022

(51) Int. Cl. E21B 44/02; G05B 13/04

(52) U.S. Cl. CPC E21B 44/02; G05B 13/048; G05B 13/042; E21B 2200/20

(57) ABSTRACT

A system and method for calculating optimal parameters for drilling are provided. The system includes a memory, a data storage unit, and a processor. The method comprises retrieving well information, analyzing the information, reading current and past well parameters, and calculating an optimal set of parameters by a predetermined algorithm.

### FIELD OF DISCLOSURE

The present application relates generally to a system and method for analyzing and predicting optimal parameters associated with a drilling site. The system and method can be carried out by a predetermined algorithm that predicts drill parameters based on current and past information related to drilling sites.

### BACKGROUND AND SUMMARY

In the current drilling market, there is no one-size-fits-all drilling solution. Because of differences in geology and location, each wellsite and wellbore requires different parameters tailored for efficiency. These parameters can include without limitation bit design, BHA design, other drilling parameters, mud properties, and production results based on desired outcome. To find the best parameters for a given well site, one has limited options. One can make a best estimate based on prior drilling parameters, but this may lead to inexact results including, for example, human error. And even if one can organize such large amounts of information, this process can be difficult and time-consuming. Therefore, there are deficiencies in the current market that leave room for improvement.

The current disclosure provides a system and method for generating a predictive model that calculates a set of parameters for optimal drilling. The model retrieves well information from current and past well projects. After retrieving the information, the information is stored in a data storage unit. This storage benefits the user by sorting the information into usable categories. Rather than sifting through unfiltered information, the model separates the information into discernable, readable groups. Once this information is separated into relevant categories, the model analyzes the relationships between each category. That is, the model determines what relationships, if any, exist between given categories. As a non-limiting example, the model may find that a specific BHA design correlates with higher efficiency regarding a mud property. Other relationships can be found. These relationships are observed by the model. When a new well project is proposed, the system feeds a proposed set of well parameters into the predictive model. Once again, this proposed set of well parameters may be stored in the data storage unit. The predictive model compares the proposed set of well parameters with the categories analyzed earlier. Based on past analysis, the predictive model calculates a new set of parameters for the drilling operation based on a predetermined algorithm.

In creating this optimal or near optimal set of parameters, the predictive model benefits the physical well bore. For example, the optimal or near optimal parameters can, for example, extend bit life, increase the rate of penetration (ROP), increase the accuracy of steering targets, reduce tool failures, and/or reduce shock and vibrations.

The system and method improve on other methods of determining drilling parameters. The predictive model saves time and effort that would otherwise be used by human efforts. Also, human error may be reduced. Furthermore, the data storage unit improves organization of the data. It also improves security of the well information—by storing the well information in the data storage unit, the information can be securely stored away from interfering parties.

Embodiments of the present disclosure provide a system for creating and applying a predictive model for the optimization of well drilling operation parameters, the system comprising: a memory; a data storage unit configured to store data associated with well drilling operation information gathered by a processor; and the processor. The processor is configured to retrieve information associated with well drilling operation; then store, after retrieval, the well drilling operation information in the data storage unit. After storage, the processor separates the well drilling operation information into one or more categories then analyzes the one or more well drilling operation categories. Then, the processor generates, after analyzing the well drilling operation categories, a predictive model configured to determine an optimal, e.g., near optimal or cost-effective, set of parameters for a particular well drilling operation wherein the predictive model comprises a model of the well drilling operation's potential parameters anticipated by a predetermined algorithm. Then, the processor updates the predictive model with new information associated with well drilling operation categories wherein the information has been retrieved and stored in the data storage unit. Then, the processor calculates, by the predictive model, a new optimal set of parameters for the well drilling operation.

Embodiments of the present disclosure provide a method for creating and/or applying a predictive model for the optimization of well drilling operation parameters. The method comprises: retrieving information associated with well drilling operation; storing, after retrieval, the well drilling operation information in the data storage unit; separating, after storage, the well drilling operation information into one or more categories; analyzing the one or more well drilling operation categories; generating, after analyzing the well drilling operation categories, a predictive model configured to determine an optimal set of parameters for a well drilling operation wherein the predictive model comprises a model of the well drilling operation's potential parameters anticipated by a predetermined algorithm; updating the predictive model with new information associated with well drilling operation wherein the information has been retrieved and stored in the data storage unit; and calculating, by the predictive model, a new optimal set of parameters for the well drilling operation.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a system diagram according to an exemplary embodiment.

FIG. 2 is a flow chart diagram according to an exemplary embodiment.

FIG. 3 is a flow chart diagram according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

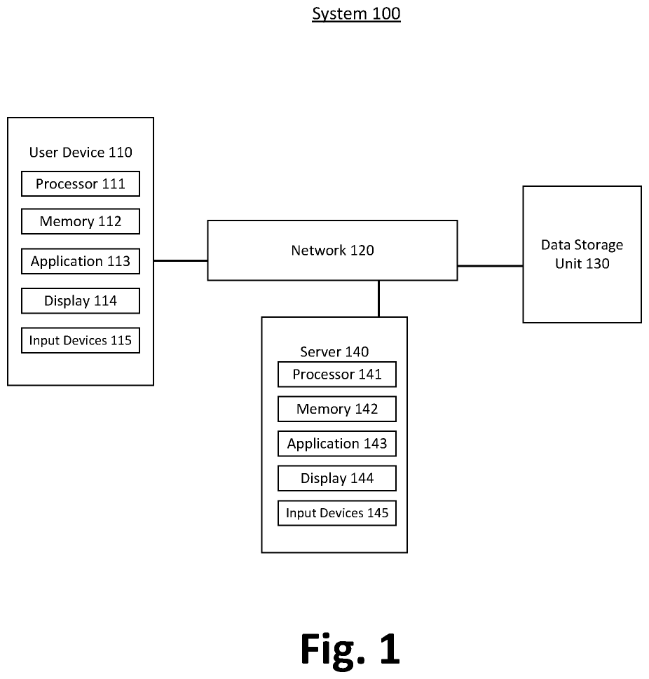

FIG. 1 is a block diagram according to an exemplary embodiment. FIG. 1 illustrates a system 100 according to an example embodiment. The system 100 may comprise a user device 110, a network 120, a data storage unit 140, and a server 140. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 111, a memory 112, and an application 113. The processor 111 may be a processor, a microprocessor, or other processor, and the user device 110 may include one or more of these processors. The processor 111 may include processing circuitry, which may comprise additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may often not be rewritten, but it may be read many times. A read/write memory may be programmed and re-programed many times after leaving the factory. It may also be read many times. The memory 112 may be configured to store one or more software applications, such as the application 113, and other data, such as user's private data and other information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and/or perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touchscreen, keyboard, mouse, cursor-control device, microphone, digital camera, video recorder or camcorder. These devices may be used to enter information and interact with the software and other devices described herein.

System 100 may include one or more networks 120. In some examples, the network 120 may be one or more of a wireless network, a wired network or any combination of a wireless network and a wired network and may be configured to connect the user device 110, the server 140, and the data storage unit 140. For example, the network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 120 may include, without limitation, telephone lines, fiber optics, IEEE Ethernet 902.3, a wide area network, a wireless personal area network, a LAN, or a global network such as the Internet. In addition, the network 120 may support an Internet network, a wireless communication network, a cellular network, or the like, or any combination thereof. The network 120 may further include one network, or any number of the exemplary types of networks mentioned above, operating as a stand-alone network or in cooperation with each other. The network 120 may utilize one or more protocols of one or more network elements to which they are communicatively coupled. The network 120 may translate to or from other protocols to one or more protocols of network devices. Although the network 120 is depicted as a single network, it should be appreciated that according to one or more examples, the network 120 may comprise a plurality of interconnected networks, such as, for example, the Internet, a service provider's network, corporate networks, and home networks. The network 120 may further comprise, or be configured to create, one or more front channels, which may be publicly accessible and through which communications may be observable, and one or more secured back channels, which may not be publicly accessible and through which communications may not be observable.

System 100 may include a data storage unit 130. The data storage unit 130 may be one or more data storage units configured to store technical or other data, including without limitation, private data of users or operators, accounts of users or operators, identities of users o operators, and certified and uncertified documents. The data storage unit 130 may comprise a relational data storage unit, a non-relational data storage unit, or other data storage unit implementations, and any combination thereof, including a plurality of relational data storage units and non-relational data storage units. In some examples, the data storage unit 130 may comprise a desktop data storage unit, a mobile data storage unit, or an in-memory data storage unit. Further, the data storage unit 130 may be hosted internally by the server 140 or may be hosted externally of the server 140, such as by a server, by a cloud-based platform, or in any storage device that is in data communication with the server 140.

System 100 may include a server 140. The server 140 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 140 may include a processor 141, a memory 142, and an application 143. The processor 141 may be a processor, a microprocessor, or other processor, and the server 140 may include one or more of these processors. The processor 141 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 141 may be coupled to the memory 142. The memory 142 may be a read-only memory, write-once read-multiple memory or read/write memory, e.g., RAM, ROM, and EEPROM, and the server 140 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it often may not be rewritten, but it may be read many times. A read/write memory may be programmed and re-programed many times after leaving the factory. It may also be read many times. The memory 142 may be configured to store one or more software applications, such as the application 143, and other data, such as user's private data and account information.

The application 143 may comprise one or more software applications comprising instructions for execution on the server 140. In some examples, the server 140 may execute one or more applications, such as software applications, that enable, for example, network communications with one or more components of the system 100, transmit and/or receive data, and perform the functions described herein. Upon execution by the processor 141, the application 143 may provide the functions described in this specification, specifically to execute and perform the steps and functions in the process flows described below. For example, the application 143 may be executed to perform receiving web form data from the user device 120 and the storage device 160, retaining a web session between the user device 120 and the storage device 160, and masking private data received from the user device 120 and the storage device 160. Such processes may be implemented in software, such as software modules, for execution by computers or other machines. The application 143 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 140 may further include a display 144 and input devices 145. The display 144 may be any type of device for presenting visual information such as a computer monitor, a flat panel display, and a mobile device screen, including liquid crystal displays, light-emitting diode displays, plasma panels, and cathode ray tube displays. The input devices 145 may include any device for entering information into the server 140 that can be available and supported by the server 140, such as a touchscreen, keyboard, mouse, cursor-control device, microphone, digital camera, video recorder or camcorder. These devices may be used to enter information and interact with the software and other devices described herein.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 140, the network 140, and the data storage unit 130 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

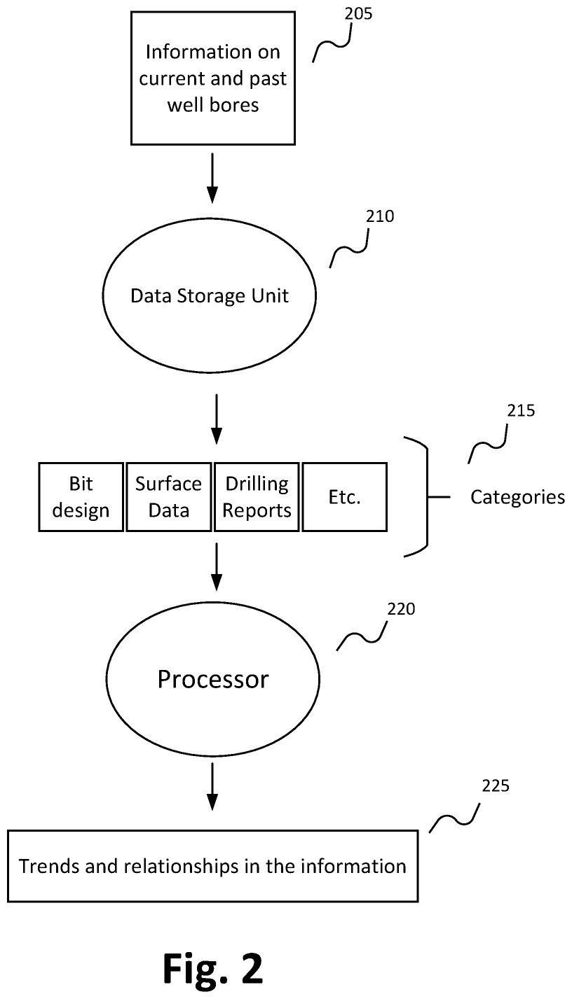

FIG. 2 is a block diagram according to an exemplary embodiment.

In the predictive model, a large amount of information is analyzed in order to calculate an optimal set of parameters for a drilling site. The model is fed this information on current and past well bores and drilling operations. The information can be extremely varied, including physical characteristics of the drill itself and the drill site. An illustrative but non-limiting list of examples of information can include: bit design, BHA design, surface data, subsurface data, drilling reports, seismic data, bit life, ROP, steering targets, tool failures, other tool information, shocks and vibrations data, formation of the well bores, casing points, location of well bores, general surface parameters, weight on bit (WOB), torque stand pipe pressure (SPP), revolutions per minute (RPM), downhole logs, geosteering data, directional drilling data, drilling reports, other BHA components, and mud properties. Downhole logs may include information related to gamma ray (GR), azimuthal GR, and shocks and vibrations. Subsurface data may include lithology, porosity, density, sonic velocity, hardness, mineralogy, formation pressure, fluid type, structural position, stress direction and magnitude, and other seismic data. Geosteering data may include bed dip, angle of incidence, stratigraphic position, and correlation confidence. Directional drilling data may include inclination, azimuth, continuous inclination, and steering force. Drilling reports may include categorical data on operations, depths drilled, time drilled, incidents, and 3^{rd} party providers. Bit information can include profile, blade count, cutter size, cutter shape, back rake angles, depth of cut, gage length, and nozzle count. Other BHA information can include push the bit RSS, point the bit RSS, hybrid RSS, motor assisted RSS, motor, adjustable kick-off (AKO), and flex or no flex information.

This information in action 205 is fed into a data storage unit 210. The function of the data storage unit is to house in the information in a single location, thus promoting security and better organization. The information may be fed into the data storage unit by a user device or some processor associated with the user device such as user device 110 in FIG. 1. Alternatively, the information may be fed into the storage unit by a server or some processor associated with the server such the server 140 in FIG. 1. In either case, the information may be fed into the data storage unit over a network 120.

Once the information has been stored in the data storage unit, the information may be separated into categories in action 215. FIG. 2 shows that the information may be separated into categories for bit design, surface data, and drilling reports. It is understood that FIG. 2 is illustrative and that a plurality of categories may be created. Additionally, each category may share information due to overlap in subject matter. For example, a drilling report category and a surface data category may share information. Further subcategories can be made. For example, gage length may be categorized under the bit design category which itself may be categorized in the larger category of drilling reports. A plurality of subcategories can be made. These categories may be predetermined, or they be made on an ad hoc basis by the user. Furthermore, these categories may be changed by the user at any point in the process. If some information does not fit within an existing category, there may exist a separate folder for miscellaneous information. This information may be later categorized manually or by some automatic process.

After the information has been categorized, the categories are analyzed by the processor in action 220. Once it analyze the categories, the processor is configured to identify trends and/or relationships in the information in action 225. The processor may be the processor associated with the user device, the server, or some other processor. The processor may analyze the categories while they reside in the data storage unit. As a result of analyzing the information in the categories, the processor may find trends and relationships between one or more categories. The processor may also note trends and relationships as a function of time, location, or some other function. The types of trends and relationships that can be found by the processor can vary to a large degree. For example, the processor may determine whether there is a positive, negative, or no correlations between a subset of the categories. Furthermore, action 225 may occur one or more times. The user may add or take away certain information or categories, then run the analysis again to observe the difference in outcomes.

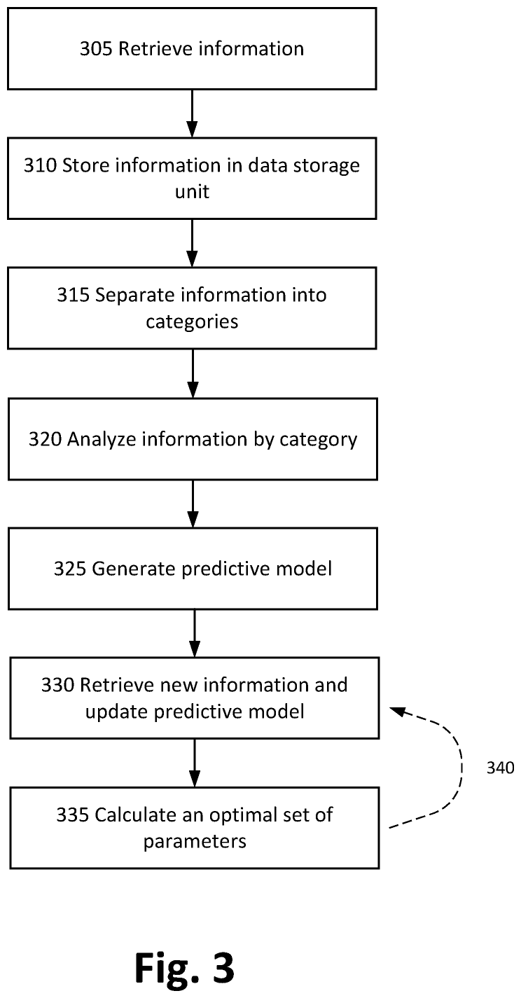

FIG. 3 is a flow chart according to an exemplary embodiment.

The method of FIG. 3 can begin with action 305 where the processor retrieves current past information related to well bores, drilling, and other information related to drill sites. To see an illustrative but non-exhaustive list of contemplated information, see action 205 in FIG. 2. The processor may be a part of a user device or some other server. The information may be collected manually or by some predetermined retrieval algorithm or by some other manner.

In action 310, after retrieval the information is stored in a data storage unit. The storage action itself may be performed by a processor. The processor may be a part of the user device or a server. The data storage device is explained in greater detail with reference to FIG. 1.

In action 315, after storage the processor separates the information into categories. This step is explained with greater detail in FIG. 2. The processor may be a part of the user device or a server.

In action 320, the processor analyzes the information by category and notices any trends or relationships between one or more categories. The processor may be a part of the user device or a server. This action is explained with greater detail in FIG. 2.

In action 325, the processor generates a predictive model configured to determine an optimal or near optimal set of parameters for a well drilling operation wherein the predictive model comprises a model of the well drilling operation's potential parameters anticipated by a predetermined algorithm. The predictive model may be manually changed by the user, if desired. The model may be changed according to information later introduced to the processor, if desired. The parameters may generally be the same or even additional to the categories of information from action 305.

In action 330, the processor retrieves new information from well bores and information related to well sites. This information may be the same as the information retrieved in action 305 or different. The processor may, after retrieving this information, store the new information in the data storage unit, separate the information into categories, and update the predictive model. The predictive model may be updated to become more accurate, or simply to change the desired outcome of the model. Again, the user may manually update the model to achieve a desired outcome, if desired.

In action 335, the predictive model calculates an optimal set of parameters. The parameters may be for a new well bore or drilling site. In action 340, new information can again be retrieved to update the predictive model. This action can happen multiple times. Action 340 may be initiated manually by the user or by the processor itself by some predetermined algorithm.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

Further, it is to be understood that the terminology used herein is for the purpose of describing embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

We claim:

1. A system for creating and applying a predictive model for the optimization of well drilling operation parameters, the system comprising:
a memory;
a data storage unit configured to store data associated with well drilling operation information gathered by the processor; and
a processor configured to conduct one or more of the following:
retrieve information associated with a well drilling operation;
store, after retrieval, the well drilling operation information in the data storage unit;
separate, after storage, the well drilling operation information into one or more categories;
analyze the one or more well drilling operation categories;
generate, after analyzing the well drilling operation categories, a predictive model configured to determine an optimal set of parameters for a well drilling operation wherein the predictive model comprises a model of the well drilling operation's potential parameters anticipated by a predetermined algorithm;
update the predictive model with new information associated with well drilling operation categories wherein the information has been retrieved and stored in the data storage unit; and
calculate, by the predictive model, a new optimal set of parameters for the well drilling operation.

2. The system of claim 1 wherein the categories associated with well drilling operation comprises at least: surface parameters, downhole logs, and subsurface data.

3. The system of claim 1 wherein the categories associated with well drilling operation comprises at least: geosteering data, directional drilling data, and drilling reports.

4. The system of claim 1 where the categories associated with well drilling operation comprises at least: bottom hole assembly (BHA) component data and drilling mud properties.

5. A method for creating a applying a predictive model for the optimization of well drilling operation parameters, the method comprising:
retrieving information associated with well drilling operation;
storing, after retrieval, the well drilling operation information in the data storage unit;
separating, after storage, the well drilling operation information into one or more categories;
analyzing the one or more well drilling operation categories;
generating, after analyzing the well drilling operation categories, a predictive model configured to determine an optimal set of parameters for a well drilling operation wherein the predictive model comprises a model of the well drilling operation's potential parameters anticipated by a predetermined algorithm;
updating the predictive model with new information associated with well drilling operation wherein the information has been retrieved and stored in the data storage unit; and
calculating, by the predictive model, a new optimal set of parameters for the well drilling operation.

6. The method of claim 5 wherein the categories associated with well drilling operation comprises at least: surface parameters, downhole logs, and subsurface data.

7. The method of claim 5 wherein the categories associated with well drilling operation comprises at least: geosteering data, directional drilling data, and drilling reports.

8. The method of claim 5 wherein the categories associated with well drilling operation comprises at least: bottom hole assembly (BHA) component data and drilling mud properties.
